(19) United States
(12) Patent Application Publication
(10) Pub. No.: US 2010/0065347 A1
(43) Pub. Date: Mar. 18, 2010

(54) MOTOR WITH TORQUE-BALANCING MEANS INCLUDING ROTATING STATOR AND ROTATING ROTOR

(76) Inventor: Yefim Kereth, Rehovot (IL)

Correspondence Address: STETINA BRUNDA GARRED & BRUCKER, 75 ENTERPRISE, SUITE 250, ALISO VIEJO, CA, 92656, US

(21) Appl. No.: 12/516,632

(22) PCT Filed: Nov. 26, 2007
(86) PCT No.: PCT/IL07/01455

§ 371 Date: May 28, 2009

(30) Foreign Application Priority Data
Nov. 28, 2006 (IL) 179666

(51) Int. Cl. B62D 55/00; F16F 15/30

(52) U.S. Cl. 180/9.42; 74/572.2

(57) ABSTRACT

There is provided a self torque-balancing differential mechanism (2), including two concentric counter-rotating wheels, rotatable about a central shaft (24), mutually reacting and balancing a torque of a motor drive (20) interacting with the wheels, the motor drive being concentrically or eccentrically attached to one of the wheels to power the wheel and an element coupled thereto. The motor drive has a rotor (12) connected with a second of the two wheels, to power the second wheel and the element coupled thereto. The motor drive is electrically fed via two slip-ring contactors (26, 28), and the central shaft has a carrier (22) for coupling another device thereto.

### FIELD OF THE INVENTION

The present invention relates to a torque-balancing differential mechanism for propulsion and/or for actuation of a variety of vehicles and/or systems and/or elements, acting in various mediums, such as air, water and ground.

### BACKGROUND OF THE INVENTION

There is a need for a compact or light-weight propulsion or actuation solution for different applications, limited in size and/or weight, to be cost-effective for small unmanned vehicles, robotic elements, and the like.

### SUMMARY OF THE INVENTION

It is a broad object of the present invention to provide a propulsion or actuation solution for a variety of vehicles and systems in a cost-effective manner.

In accordance with the present invention there is therefore provided a self torque-balancing differential mechanism, comprising at least two concentric counter-rotating wheels, rotatable about a central shaft, mutually reacting and balancing a torque of at least one motor drive interacting with the wheels, said motor drive having a stator concentrically or eccentrically attached to one of the wheels to power said wheel and at least one element coupled thereto, said motor drive having a rotor at least indirectly connected, with a second of said at least two wheels, to power the second wheel and at least one element coupled thereto, said motor drive being electrically fed via at least two slip-ring contactors, and said central shaft having a coupler for coupling another device thereto.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A, 1B and 1C are simplified perspective view of the concentric motor mechanism, front cross-section and perspective cross-section views of the eccentric motor mechanism, according to the present invention;

FIG. 2 is a simplified diagram of the power supply and control for the mechanism of FIG. 1;

FIGS. 3A and 3B are, respectively, perspective views of the mechanism of FIG. 1 powering two counter-rotating propellers carrying a payload;

FIG. 4 is a simplified schematic view of a propulsion system for the track vehicle, and

FIG. 5 is a simplified schematic view of a propulsion system for the track vehicle, with a different drive line configuration.

### DETAILED DESCRIPTION OF THE PREFERRED EMBODIMENTS

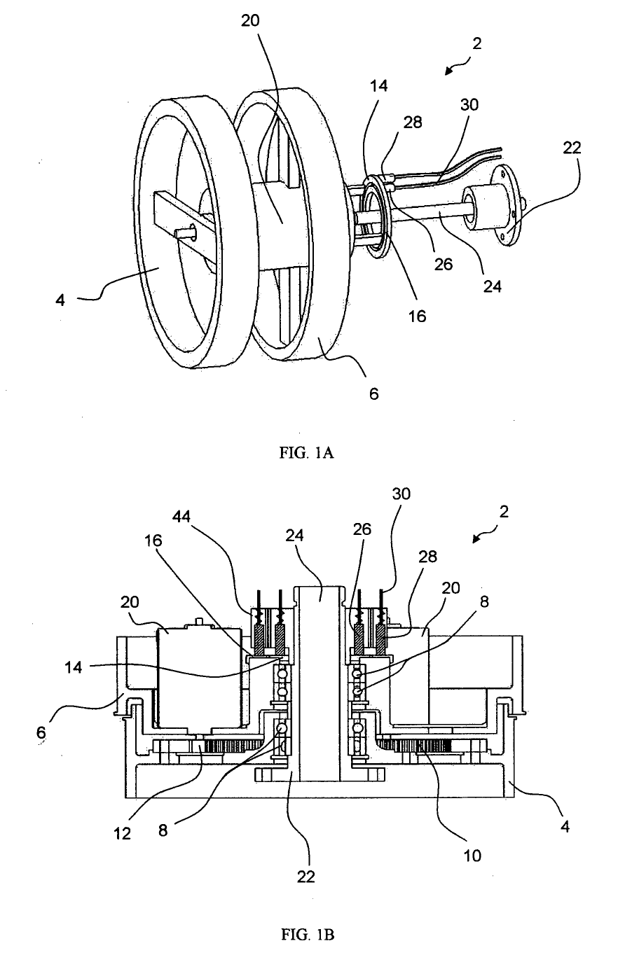

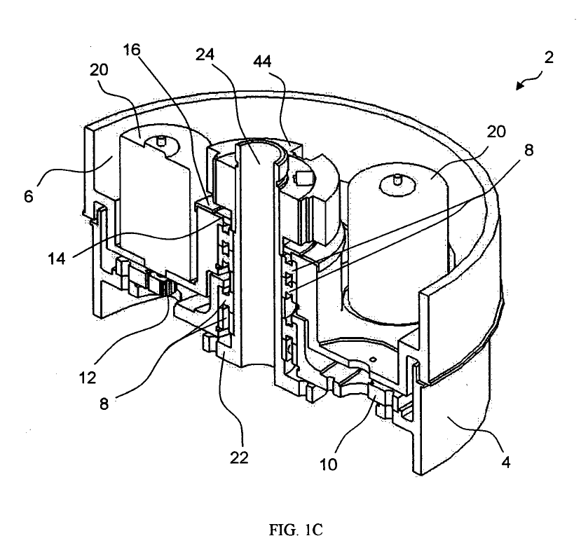

FIGS. 1A, 1B and 1C are simplified views of electro-mechanical principles of a torque-balancing differential mechanism 2 with a concentric motor (FIG. 1A) and eccentric motors (FIGS. 1B, 1C) configurations. The differential mechanism 2 includes two concentric wheels 4 and 6 rotatable about a central shaft 24 and interacting with traction elements, e.g., tires and tracks for land transportation, propellers for fluids or devices such as drill bits, for solids. A first wheel 4 is connected to a rotor of a motor drive 20 and a second wheel 6, respectively, concentrically (FIG. 1A) or eccentrically (FIGS. 1B, 1C) carry the stator of motor drive 20. The power is supplied to the motor drive 20 by at least two rotating conductive slip-rings 14 and 16, concentrically attached to the second wheel 6, and by contactors 26 and 28, carried by the collector house 44, through wires 30.

At least one driving motor 20, drives the first wheel 4 and the traction element/device attached thereto in one rotating direction, while the motor “stators” carried by the second wheel 6 rotates together with the second wheel 6 and the traction element/device attached thereto, in an opposite rotating direction and provides the torque reaction required for a propulsion/actuation of a traction element/device attached to the first wheel 4 and for the balancing of the mechanism. In addition to the standard requirement for balancing the rotors, it is also necessary to balance the stators. The pair of mutually counter-rotating elements is basically an inherent differential-single-axis propulsion/actuation mechanism with natural torque-balancing capability.

One or more payloads or other devices may be carried by, or coupled to, a single or a multiplicity of the carriers 22, which are at least indirectly coupled to the freely rotatable central shaft 24, on one end or on both ends of the shaft 24.

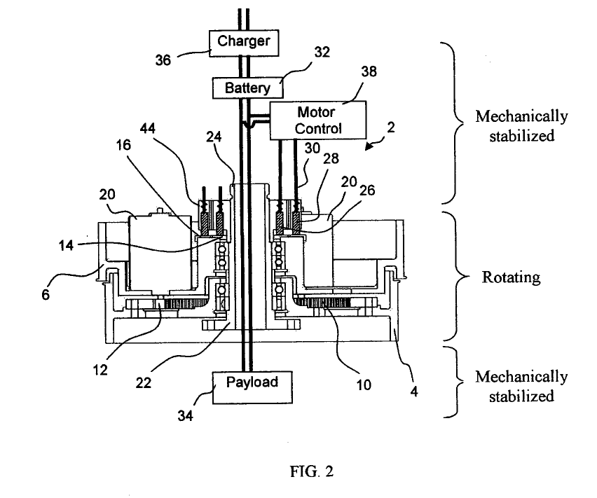

FIG. 2 illustrates a manner of applying a power supply to the motor drives 20 through the wires 30, contactors 26 and 28 and rotating conductive slip-rings 14 and 16. The conductive slip-rings 14 and 16 are isolated by dielectric material of wheel 6. The battery 32 can be a part of the payload 34, or otherwise. Also seen is a motor control 38.

The rotor of the driving motor 20 allows wheel 4 to be driven in one rotating direction while its “stator” (which is actually non-static) allows the other related wheel 6 to be driven in an opposite rotating direction and provides the torque reaction required for the propulsion of the vehicle along the medium or for the angular actuation of devices attached to the wheels 4 and 6.

The carrier 22 and the freely rotatable central connection shaft 24 can be stabilized regardless of the fact that all of the wheels and related traction elements are rotating. Advantageously, the payload carrier is provided with threads and/or holes and at least one centering pin or similar centering mechanism for connecting to the payload structure, or to another vehicle/device, and an electrical connector for the motor drives power and control. At the center of the carrier 22 and of the central shaft 24 there is a passageway, optionally being hollow, for wires 30 that extend from the other side of the central shaft 24.

The carrier 22 can be on either or on both sides of the differential mechanism. This configuration enables interconnection between more than one module of the mechanism, between the mechanism and additional stabilizing and/or steering devices and/or other elements, as described hereinafter. It also enables the supply of power, communication, fluids, etc., along all of the interconnected mechanisms by the hollow shaft 24.

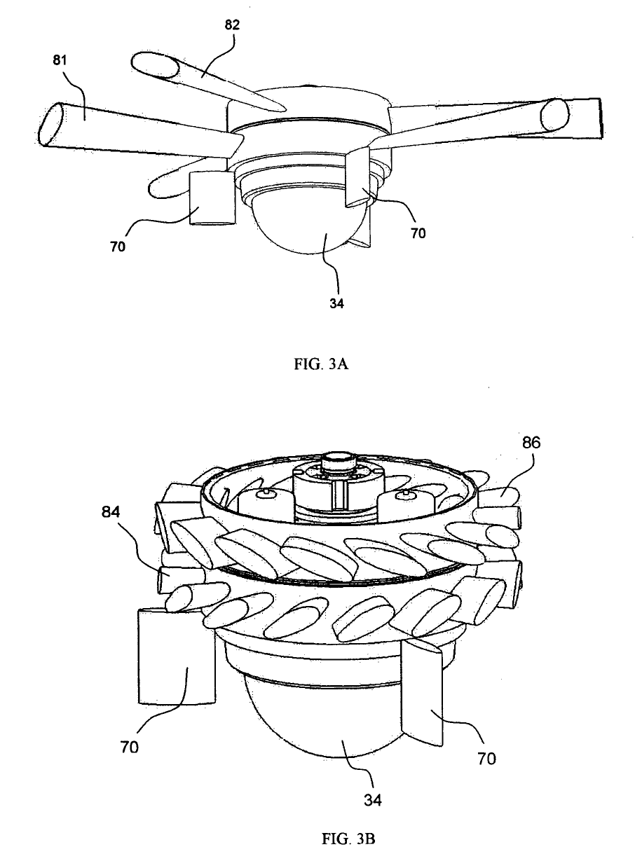

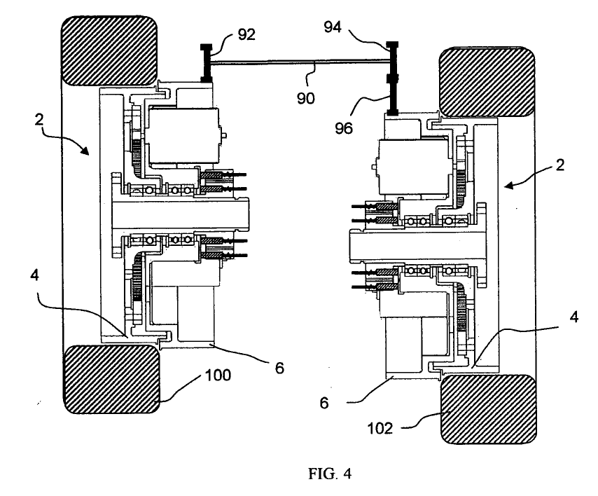

FIGS. 3A and 3B are perspective views of propulsion systems for ultra-light-weight unmanned aerial and marine vehicles, based on the differential mechanism 2. The payload can be dynamically stabilized and steered using stabilization/steering surfaces 70, which utilize the air/water or other fluid stream under/behind the propellers 81 and 82, or 84 and 86. Differential mechanism 2 for propulsion over a solid medium can be similarly implemented (not shown).

Differential mechanism 2 can also be applied as an electro-mechanical accumulator capable of converting the electric energy into the kinetic energy of two counter-rotating flywheels (not shown) and vice versa, capable of converting the kinetic energy into electric energy by switching the motor drives 20 into generator mode.

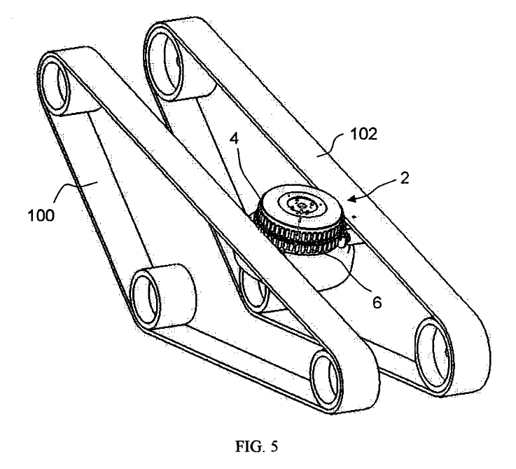

FIG. 4 is a simplified schematic view of two propulsion mechanisms 2 for a track (or wheeled) vehicle. The wheel 4 of the left-side propulsion mechanism 2 directly interacts with the track 100 and the wheel 4 of the right-side propulsion mechanism 2 directly interacts with the track 102. The wheels 6 of both the left and right mechanisms directly interact with an embedded steering differential operated by the steering cross shaft 90 and steering transmission wheels 92, 94 and 96.

FIG. 5 is a simplified schematic view of propulsion mechanism 2 for a track vehicle with s different drive line configuration. The wheels 4 and 6 directly interact, via spurs, with the tracks 100 and 102, respectively. The counter-rotation of wheels 4 and 6 propel the vehicle forward or backward. The steering can be achieved by braking one of the wheels 4 or 6. In this configuration, it is possible to change the vehicle's center of gravity just by releasing the coupling between the propulsion mechanism 2 and the vehicle's chassis. When the coupling is released, the propulsion mechanism 2 will be able to move over the tracks 100 and 102. The propulsion mechanism weight usually constitutes a significant portion of the overall weight of the vehicle, and therefore, its relocation along the vehicle will shift the vehicle's center of gravity.

All of above-described motor drives, actuators and steering/stabilization surfaces can be either locally and/or remotely controlled.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1-9. (canceled)

10. A self torque-balancing differential mechanism, comprising:
at least two concentric counter-rotating wheels, rotatable about a central shaft, mutually reacting and balancing a torque of at least one motor drive interacting with the wheels;
said motor drive being concentrically or eccentrically attached to one of the wheels to power said wheel and at least one element coupled thereto;
said motor drive having a rotor being at least indirectly connected with a second of said at least two wheels, to power the second wheel and at least one element coupled thereto;
said motor drive being electrically fed via at least two slip-ring contactors, and
said central shaft having a carrier for coupling another device thereto and said central shaft being hollow for facilitating supplying power, communication or fluids, etc. through the shaft.

11. The mechanism as claimed in claim 10, wherein said motor drive is an electric motor with a direct mechanical link or a transmission.

12. The mechanism as claimed in claim 10, wherein said element is a traction element capable of propelling the mechanism in or on a medium or a flywheel capable of accumulating kinetic energy.

13. The mechanism as claimed in claim 11, wherein said electric motor is connected via said slip-ring contactors to a battery/generator.

14. The mechanism as claimed in claim 13, wherein said battery/generator is attached to said carrier.

15. The mechanism as claimed in claim 10, wherein two or more mechanisms are interconnected by coupling, at least indirectly, to the central shaft of each mechanism to provide improved propulsion.

16. The mechanism as claimed in claim 12, wherein said traction elements are selected from the group of devices including tracks, tires, propellers, drill bits, and other devices capable of interacting with the medium.

17. The mechanism as claimed in claim 10, being operative while interacting with two or more tracks to change the vehicle's center of gravity by releasing the coupling between the propulsion mechanism and the chassis.

18. A self torque-balancing differential mechanism, comprising:
at least two concentric counter-rotating wheels, rotatable about a central shaft, mutually reacting and balancing a torque of at least one motor drive interacting with the wheels;
said motor drive being concentrically or eccentrically attached to one of the wheels to power said wheel and at least one element coupled thereto;
said motor drive having a rotor being at least indirectly connected with a second of said at least two wheels, to power the second wheel and at least one element coupled thereto;
said motor drive being electrically fed via at least two slip-ring contactors;
said central shaft having a carrier for coupling another device thereto; and
the differential mechanism, while interacting with two or more tracks, is operative to change the vehicle's center of gravity by releasing a coupling between the propulsion mechanism and the chassis.

19. The mechanism as claimed in claim 18, wherein said central shafts are hollow facilitating supplying power, communication or fluids, etc. along the shafts.

20. The mechanism as claimed in claim 18, wherein said motor drive is an electric motor with a direct mechanical link or a transmission.

21. The mechanism as claimed in claim 18, wherein said element is a traction element capable of propelling the mechanism in or on a medium or a flywheel capable of accumulating kinetic energy.

22. The mechanism as claimed in claim 18, wherein said electric motor is connected via said slip-ring contactors to a battery/generator.

23. The mechanism as claimed in claim 22, wherein said battery/generator is attached to said carrier.

24. The mechanism as claimed in claim 18, wherein two or more mechanisms are interconnected by coupling, at least indirectly, to the central shaft of each mechanism to provide improved propulsion.

25. The mechanism as claimed in claim 21, wherein said traction elements are selected from the group of devices including tracks, tires, propellers, drill bits, and other devices capable of interacting with the medium.

26. The mechanism as claimed in claim 18, being operative while interacting with two or more tracks, to change the vehicle's center of gravity by releasing the coupling between the propulsion mechanism and the chassis.
